(19) United States
(12) Patent Application Publication
(10) Pub. No.: US 2013/0091002 A1
(43) Pub. Date: Apr. 11, 2013

(54) SYSTEM AND METHOD FOR COUPON VALIDATION

(71) Applicants: William CHRISTIE, Fairfield, CT (US); Henri Lellouche, Fairfield, CT (US); Ray Moran, Shelton, CT (US)

(72) Inventors: William CHRISTIE, Fairfield, CT (US); Henri Lellouche, Fairfield, CT (US); Ray Moran, Shelton, CT (US)

(73) Assignee: News America Marketing Properties, LLC.

(21) Appl. No.: 13/470,179

(22) Filed: May 11, 2012

Related U.S. Application Data
(63) Continuation of application No. 13/253,590, filed on Oct. 5, 2011, now abandoned.

(51) Int. Cl. G06Q 30/02

(52) U.S. Cl. 705/14.26

(57) ABSTRACT

Systems and methods are provided for verifying the validity of a coupon to facilitate coupon redemption. A coupon is provided with a coupon code. The coupon code has at least an encoded URL and an encrypted unique coupon identifier. A scanner scans the encrypted unique coupon identifier on the coupon. The scanner accesses a verification server via the URL. The verification server decrypts the encrypted unique coupon identifier and determines whether the decrypted unique coupon identifier is a valid coupon identifier.

### BACKGROUND OF THE INVENTION

This application is a continuation of U.S. patent application Ser. No. 13/253,590, filed Oct. 5, 2011, the disclosure of which is incorporated by reference herein in its entirety.

### FIELD OF THE INVENTION

Various embodiments relate generally to the field of coupon generation and validation. More particularly, various embodiments relate to validating coupons to facilitate coupon redemption.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Traditional marketing approaches have included the use of discount offers distributed to consumers in the form of paper or printed certificates commonly referred to as coupons. Such coupons are generally distributed via, e.g., mailers or newspaper cutouts, or presented to consumers at a retail location. These coupons typically contain transactional data describing a particular transaction enabled by the coupon, such as a product's description, the coupon's amount or value, an expiration date, etc.

With the advent of the Internet, online shopping and advertising has become more prevalent. For example, many retailers now maintain websites to allow consumers to shop online for products and/or obtain certain information related to such products. Additionally, many businesses now also provide coupons to consumers in an electronic format. That is, electronic coupons can be sent to consumers via email or made available on a website containing a graphic representation of a coupon that can be printed by the consumer at his/her local printer. The printed coupon can then be taken to a retail location and redeemed by the consumer.

Due to the nature of these conventional electronic coupons and the manner in which they are distributed, it may be difficult for retailers at the point of sale (POS) to maintain accurate records for each coupon in order to promptly verify that the coupon is valid so that it might be redeemed.

### SUMMARY

In embodiments, a method for verifying the validity of a coupon to facilitate coupon redemption, comprises: scanning, using one or more computers, a URL and a coupon code on the coupon, the coupon code comprising at least an encrypted unique identifier; accessing, using the one or more computers and an electronic network connection, a verification server via the URL; obtaining, using the one or more computers and the electronic network connection, coupon information from the verification server on coupon details if the decrypted unique identifier is a valid coupon identifier; and determining whether the coupon is valid or invalid based on the coupon information obtained from the information obtained.

In embodiments, the URL may be encoded in the coupon code, and further comprising: decoding the encoded URL to obtain the URL.

In embodiments, the method, system and program product may further comprise: obtaining from the scanned coupon code a media access control (MAC) address associated with a customer that has requested to print the coupon; and if the coupon is determined to be invalid, then transmitting, using the electronic network connection, information to the verification server to prevent the verification server from authorizing printing of a coupon in response to a future access having a reference to that Mac address.

In embodiments, the method, system and program product may further comprise: if the decrypted unique identifier is a valid coupon identifier, displaying coupon information to a user, and if the decrypted unique identifier is not a valid coupon identifier, displaying an error message to the user.

In embodiments, the coupon information includes at least one selected from the group of brand, discount value, product purchase requirement or print date.

In embodiments, the encrypted unique coupon identifier further comprises at least one selected from the group of information related to an offer, value, date, time of print, IP address, browser type or session information.

In embodiments, the coupon code may be a 2D barcode, and/or a quick response (QR) code.

In embodiments, the QR code has dimensions of approximately 1.25×1.25 inches.

In embodiments, the URL may be encoded in the coupon code, and the encrypted unique coupon may be encoded with a same code as the URL.

In embodiments, the URL may be encoded in the coupon code, and the encrypted unique coupon may be encoded with a different code than the URL.

In embodiments, the URL may be encoded in the coupon code, and further comprising decoding, using the one or more computers, the encoded URL to obtain the URL.

In embodiments, the coupon information obtained comprises text for the coupon identified by the decrypted unique identifier, and the determining step comprises a merchant comparing text on a coupon presented by a customer to the text provided in the coupon information.

In embodiments, a method for verifying the validity of a coupon to facilitate coupon redemption, comprises: receiving, by one or more computers from a network connection, a signal including an encrypted unique identifier from a scanner; decrypting, using the one or more computers, the encrypted unique identifier to obtain the unique identifier; determining, using the one or more computers, information relating to whether the unique identifier is for a valid coupon identifier or invalid as a coupon identifier; and transmitting, using the one or more computers and network connection, the determination of whether the coupon identifier is a valid coupon identifier or an invalid coupon identifier, to a third party.

In embodiments, the method, system and program product may further comprise obtaining from the encrypted unique identifier a media access control (MAC) address associated with a customer that has requested to print the coupon; receiving invalidity information from the electronic network connection that the coupon presented by this customer is invalid; and providing, using the one or more computers, the invalidity information to a database for future reference to prevent authorizing printing of a coupon in response to a future access having a reference to that Mac address.

In embodiments, a method for creating a coupon to facilitate coupon redemption, comprises: accessing, using one or more computers and an electronic network connection, a coupon server to create a coupon; assigning, using the one or more computers, an encrypted unique identifier to the coupon; associating, using the one or more computers, a QR code encoded with at least a URL and the encrypted unique identifier with the coupon; and authorizing printing the coupon with the QR code printed on the coupon.

In embodiments, the method, system and program product may further comprise obtaining a media access control (MAC) address of a customer requesting printing of the coupon; and adding, using one or more computers, the MAC address encoded into the QR code on the coupon.

In embodiments, a coupon comprises: a tangible medium; the tangible medium comprising a coupon code, encoded with a URL and an encrypted unique coupon identifier for validating the coupon.

In embodiments, the encrypted unique coupon identifier of the coupon may be a 2D barcode.

In embodiments, the 2D barcode may be a quick response (QR) code.

In embodiments, a system for verifying the validity of a coupon having a coupon code to facilitate coupon redemption, comprises: a scanner for scanning or having scanned the coupon code on the coupon; one or more computers configured to obtain an encrypted unique coupon identifier obtained from the coupon code; a transmitter configured to electronically transmit over one or more electronic networks the encrypted unique coupon identifier obtained from the coupon code to a verification server; a receiver configured to receive from the one or more electronic networks a determination whether the encrypted unique coupon identifier is a valid coupon code; and a display to display the determination.

In embodiments, the scanner may be a handheld device for scanning 2D barcodes and accessing the Internet.

In embodiments, the scanner may be a smart phone.

In embodiments, the coupon may be paper coupon.

In embodiments, the scanner may be located at a point of sale.

In embodiments, a system for verifying the validity of a coupon to facilitate coupon redemption, comprises: one or more computers comprising memory wherein the memory stores computer-readable instructions that, when executed, cause the one or more computers to perform the steps: accessing, using the one or more computer, one or more electronic databases, stored on one or more computer-readable media, comprising coupon information and unique coupon identifiers for valid coupons; receiving, using the one or more computers from a network connection, a signal including an encrypted unique identifier from a scanner; decrypting, using the one or more computers, the encrypted unique identifier to obtain the unique identifier; determining, using the one or more computers, information relating to whether the unique identifier is for a valid coupon identifier or invalid as a coupon identifier; and transmitting, using the one or more computers and network connection, the determination of whether the coupon identifier is a valid coupon identifier or an invalid coupon identifier, to a third party.

In embodiments of the system the one or more computers may be further configured with computer-readable instructions for performing the steps: obtaining, using the one or more computers, from the encrypted unique identifier a media access control (MAC) address associated with a customer that has requested to print the coupon; and receiving from the electronic network connection invalidity information that the coupon presented by this customer is invalid; and providing, using the one or more computers, the invalidity information to one or more databases for future reference to prevent authorizing printing of a coupon in response to a customer requesting coupon printing and having that MAC address. [00321 In embodiments, the one or more computers may be further configured with computer-readable instructions for performing the steps: accessing, using the one or more computers, the one or more databases holding MAC addresses of customers that have been determined to have presented invalid coupons, upon receiving a request to print a coupon from a customer with a MAC address; determining, using the one or more computers, whether the MAC address of the customer requesting coupon printing is a match with a MAC address listed in the one or more databases; and preventing, using the one or more computers, authorizing printing of a coupon in response to the request to print the coupon from the customer with the MAC address that matches a MAC address in the one or more databases.

In embodiments, the one or more computers may be further configured with computer-readable instructions for performing the step: transmitting, using the one or more computers and the electronic network connection, a message to the customer.

These and other advantages and features of various embodiments, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

Embodiments of the present invention are described by referring to the attached drawings, in which:

FIG. 1 is an exemplary process flow in the lifecycle of an electronic coupon;

FIG. 2 illustrates an exemplary system architecture of a coupon system;

FIG. 3 illustrates the functional architecture of the coupon system of FIG. 2;

FIG. 4 illustrates the application architecture of the coupon system of FIG. 2;

FIG. 5 illustrates an exemplary authentication process for authenticating a user accessing an integrated content management system application of the coupon system of FIG. 2;

FIG. 6 illustrates an exemplary implementation of the coupon system of FIG. 2 in a distributed environment;

FIG. 7 illustrates an exemplary coupon with an encrypted coupon identifier;

FIG. 8 illustrates an exemplary coupon verification system;

FIG. 9 is an exemplary flow chart illustrating a coupon verification process; and

FIG. 10 is a sequence diagram illustrating various exemplary processes that may be performed to verify a coupon.

### DETAILED DESCRIPTION

Various embodiments provide for electronic discount certification (e.g., coupon) generation and secure distribution, and the prevention of fraudulent printing via a coupon system operated by a coupon distributor.

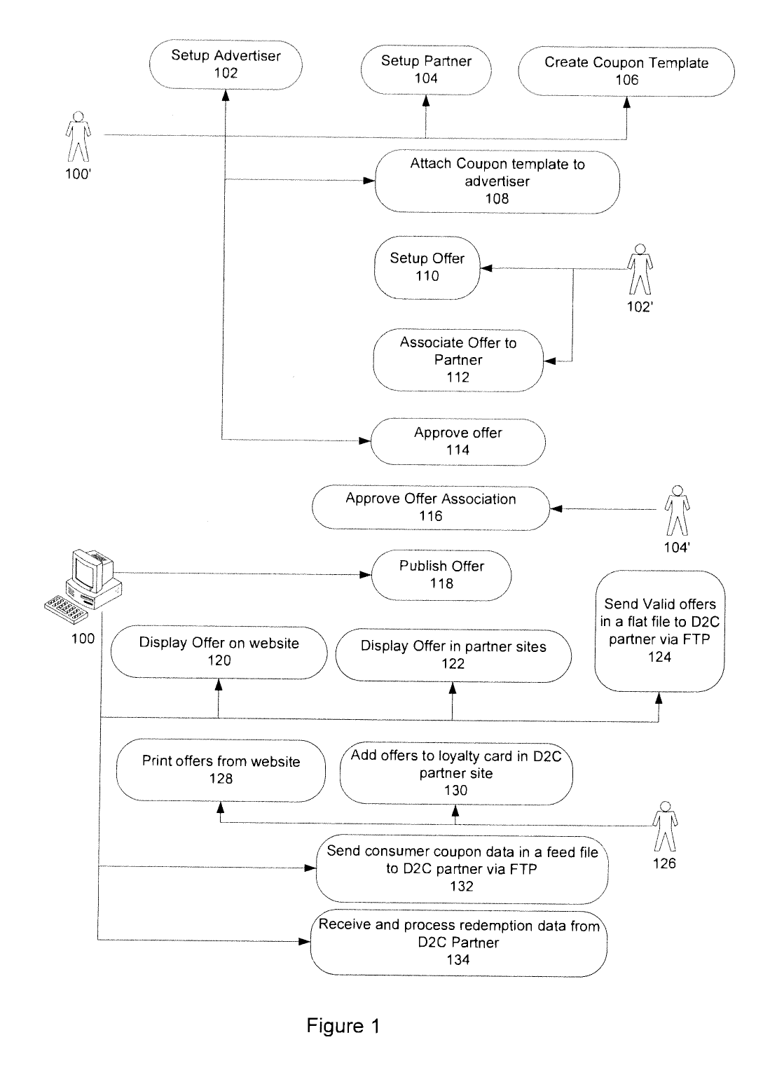

FIG. 1 illustrates an exemplary process flow in the lifecycle of an electronic coupon. As described above, electronic coupons can be provided to a user (e.g., consumer) directly by an advertiser or even a product or service retailer. Alternatively, product or service providers, retailers, or marketers may collaborate with a coupon distributor that operates a coupon system to provide coupon generation and/or an online network or distribution channel for electronic coupons. With reference to FIG. 1, an administrator 100′ of a coupon system 100 is shown as setting up an “advertiser” at 102, a “partner” at 104, and/or a coupon template at 106 to allow the advertiser 102′ to include any relevant data or details regarding the coupon. That is, the administrator 100′ obtains and enters relevant advertiser 102′ and partner 104′ information, and configures the coupon system 100 for use with the advertiser 102′ and/or the partner 104′. As utilized herein, the term “advertiser” may refer to a client (of or relative to the coupon distributor and coupon system) sponsoring offers, e.g., a marketing entity or consumer packaged goods company. A “partner” can refer to a client (of or relative to the coupon distributor and coupon system) such as, e.g., a network distribution partner of the coupon distributor that distribute products, e.g., General Mills™, Coca-Cola™, Procter & Gamble™, etc. It should be noted that advertisers and partners may also be considered to be users of the coupon system 100 (e.g., when the advertiser creates coupons using a coupon template, when the partner approves coupon association, etc. as described in greater detail below). It should also be understood that FIG. 1 illustrates single instances of the administrator, the coupon distributor, the advertiser, and the partner merely for simplicity. However, various embodiments contemplate the involvement of any number of, combination, or groups of these entities.

At 108, the administrator 100′ associates or assigns the coupon template to the advertiser 102′. At 110, the advertiser 102′ uses the coupon template associated with or assigned to the advertiser 102′ and creates an offer that provides the relevant details associated with the coupon. At 112, the advertiser 102′ associates the created offer with a partner 104′. At 114, the administrator 100 validates and approves the offers created by the advertiser 102′, and at 116, the partner 104′ verifies and approves any offers associated therewith.

At 118, the approved offers are published, e.g., online. Examples of online publishing include, but are not limited to displaying the offer on a website (provided via the coupon system 100) at 120, displaying the offer at one or more partner websites at 122, and sending the offer to a “Direct-to-card” (D2C) partner in a feed file at 124 using, e.g., a file transfer protocol (ftp). A D2C partner may be a retailer or other entity that offers loyalty cards, where the coupon system 100 can send the offer or coupon directly to a retail loyalty card associated with a particular consumer.

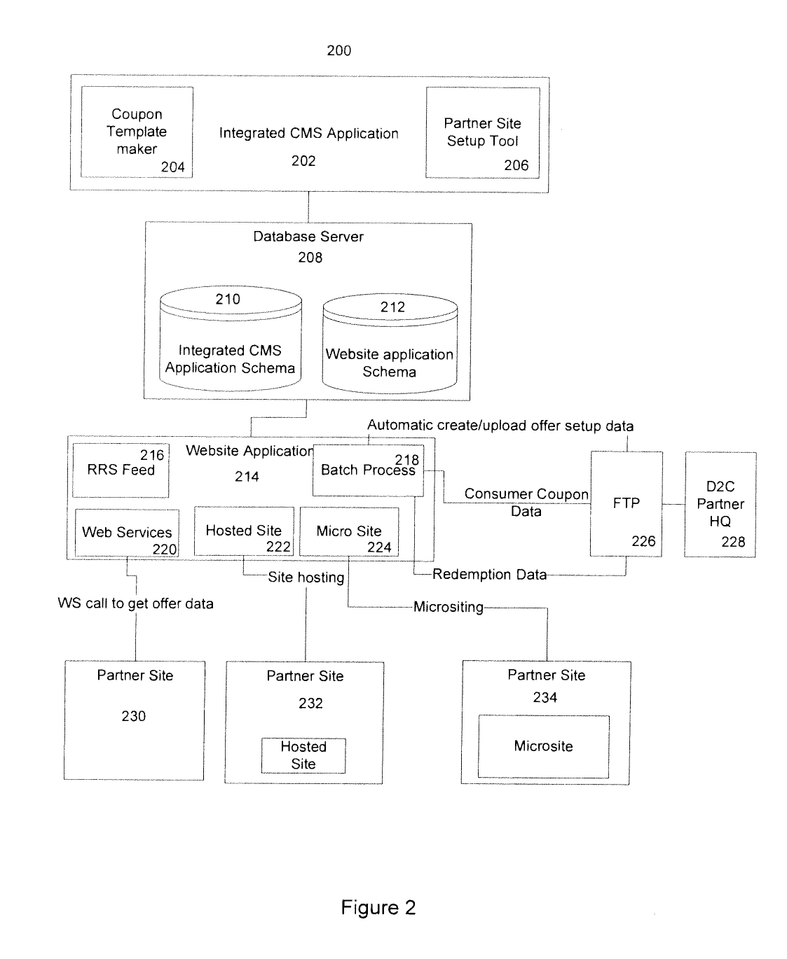

FIG. 2 illustrates an exemplary system architecture of a coupon system 200 (which would be operated and provided by, e.g., a coupon distributor) through which various embodiments may be implemented and effectuated. The coupon system 200 includes an “integrated content management system (CMS) application” 202. The integrated CMS application 202 can be used to: create coupon templates using an integrated coupon template maker tool 204; create and setup advertisers, partners, and offers as described above; and setup a partner's (that opt for site hosting) website using a partner site setup tool 206.

The coupon system 200 further includes a database server 208 that is common to the integrated CMS application 202 and the coupon system website. It should be noted that the coupon system website is effectuated by a “website application” 214 for performing the requisite processes described in greater detail below. Additionally, it should be noted that both the integrated CMS application 202 and the website application 214 can have their own independent schemas 210 and 212, respectively. That is, offer setup data flows into both the schemas 210 and 212 from the integrated CMS application 202, and is used by the website application 214 for display and integration with partner sites.

The website application 214 provides a “public-facing” website that hosts one or more webpages containing electronic coupons for display and printing by consumers. The website application 214 fetches electronic coupons from the common database server 208 between the website application 214 and the integrated CMS application 202 and displays the electronic coupons. Thus, a consumer may visit the coupon system website and browse or access one or more desired offers, and print coupons for the desired offers. The website application 214 also provides options for integration with partners. Further still, the website application 214 hosts, e.g., a Real Simple Syndication (RSS) feed 216 which is open to the public, allowing consumers to subscribe to the RSS feed 216 to receive electronic coupon data on a frequently updated basis. It should be noted that other types of web syndication or data aggregator technology may be utilized in accordance with various embodiments.

As described above, various embodiments provide the ability for a coupon distributor to send an offer or coupon directly to a retail loyalty card associated with a particular consumer via D2C partner integration. The D2C partner integration is done using a batch process component 218 hosted in a server that hosts the coupon system website, where the batch process component 218 periodically creates a flat/feed file containing the offer setup data. The file is transmitted to an ftp server 226 to be picked up by the D2C partner headquarters (HQ) 228. The batch process component 218 also creates and transmits consumer coupon data to the D2C partners, as well as imports and processes the redemption data feed file from the D2C partners transmitted via the ftp server 226.

Partner sites, such as partner sites 230, 232, and 234 illustrated in FIG. 2, are integrated with the website application 214 using various methods. In accordance with a first method, the website application 214 exposes one or more web services 220 that provide the coupon data for a particular partner. The partner can consume the web services 220 by giving out their partner ID to get coupon details. Additionally, the partner, if they so desire, can apply their own rendering logic to display the coupon on their own partner site 230.

In accordance with another method, partner site integration comprises presenting the coupon system website as a “microsite” 224 on the partner site 234. For example, the partner may include an iframe inside their own partner site/website 234, where the source will point to the coupon system website that hosts/displays the coupon data.

Further still, a method of site hosting may be utilized to effectuate partner site integration. In accordance with this method, partner site integration begins with partner site setup in the integrated CMS application 202 as described above. Once a partner site 232 is set up in the integrated CMS application, the website application 214, via a hosted site module 222, retrieves the data to display coupon data on a webpage whose look and feel will be the same as that of the partner site 232. It should be noted that this entire webpage can be hosted by one or more servers hosting the coupon system website, or alternatively, dedicated web servers.

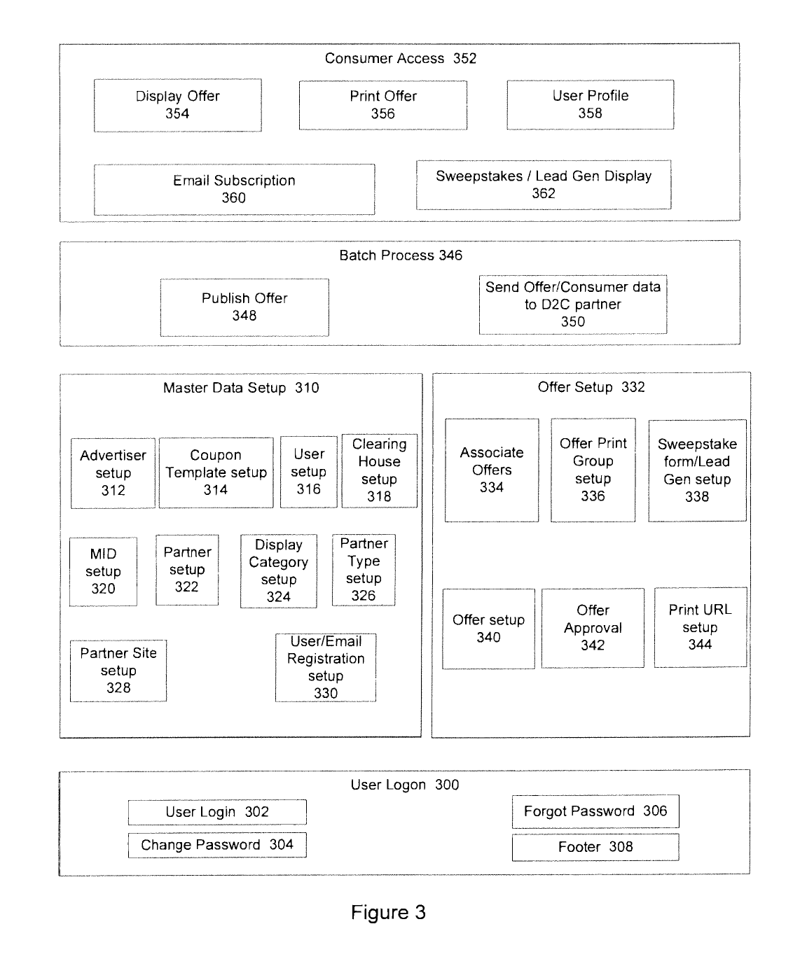

FIG. 3 illustrates the functional architecture of the coupon system described above. From a functionality perspective, a User Logon module 300, a Master Data Setup module 310, and an Offer Setup module 332 make up the integrated CMS application 202. A Batch Process module 346 and a Consumer Access module 352 make up the website application 214. It should be noted that more or less modules may be implemented within or as part of the integrated CMS application and/or website application while providing substantially similar functionality. For example, one of the aforementioned modules may be implemented in another entity of the system 200 described above. It should be further noted that each of these modules may include one or more respective user interfaces (UIs), such as, e.g., web-based graphical UIs (GUIs), and associated processes for accomplishing the various module tasks or providing user access for inputting the requisite information needed to accomplish the various module tasks.

The User Logon module 300 is configured to handle various aspects of user access and identification. For example, the User Logon module 300 controls user login processes 302, change password 304 and forgotten password 306 functionalities, as well as a footer 308 functionality in the integrated CMS application 202. It should be noted that all users of the integrated CMS system including, e.g., any administrators, advertisers, and/or partners, may access these features for their respective purposes, e.g., providing consumer access requirements/data for accessing a partner site or the coupon system website, etc.

The Master Data Setup module 310 deals with any master data setup-related functionalities. Such functionalities include, but are not limited to, the following: advertiser setup 312 (e.g., loading advertiser information into the coupon system); coupon template setup 314 (e.g., setting up coupon template layouts, offer information to be rendered, etc.); user setup 316 (e.g., setting up username and password for authorization, creating privileges and roles, assigning roles to users, etc.); clearinghouse setup 318 (e.g., maintaining an agency/company responsible for settling trading accounts, collecting and maintaining marginal monies, bringing together seekers and providers of goods, etc.); member identifier (MID) setup 320 (e.g., setting up a client's unique identifier for each member/registered consumer); partner setup 322 (e.g., setting up one or more partners, e.g., retailers or network distribution partners); display category setup 324 (setting up display categories or product types that are specified when an offer is setup, for filtering or grouping offers for consumers); partner type setup 326 (e.g., setting up partners based on whether the partner is, e.g., a “registration required” partner); partner site setup 328 (e.g., setting up micrositing information such as whether or not a microsite will contain iframes, other visual attributes, etc.); and user/email registration setup 330 (e.g., setting up a user registration process for the required registration type). All of these features are functionally a part of the integrated CMS application and can be accessed by an administrator.

The Offer Setup module 332 is configured to group certain functionalities, including but not limited to, the following: associating offers 334 (e.g., associating offers or disassociating offers with partner sites); offer print group setup 336 (e.g., setting effective coupon dates, setting offer group print limits, etc.); sweepstake form/lead generation setup 338, offer setup 340 (e.g., setting up offers specifying a type of offer provided and other related information); offer approval 342 (setting up the ability for partners to approve advertiser-submitted/created offers); and print URL setup 344 (generating print URLs associated with offers promoted by, e.g., a partner at a partner site, setting print limits, etc.) With regard to the aforementioned sweepstake form/lead generation setup 338, it should be noted that the coupon system may be used not only for coupon generation and distribution, but for sweepstakes purposes as well. That is, forms may be created and used for sweepstake and lead generation, where when a consumer clicks on a link to a sweepstake/lead generation form, the consumer information entered into the form is recorded and passed on to the client holding the sweepstake promotion. The Offer Setup module 332 is also a part of the integrated CMS application and is primarily accessed by advertisers.

Before an offer is set up, a Letter of Commitment (LOC) should be created. The LOC is specific to a single advertiser, although multiple offer programs can exist for one or more brands of an advertiser in a single LOC, and the LOC can be associated with D2C or printable coupon distribution. Moreover, a single LOC can cater to multiple timelines and multiple distribution channels. There are different types of LOCs including, for example: a time-based LOC, where an offer is valid only for a contracted time period; a print-based LOC, where an offer is valid only until a predetermined print limit is reached; and a partnership-based LOC, which is similar to the print-based LOC, but also includes a “new coupon alert spotlight,” a “solo page,” and a “web link.” Additional LOC types include a coupon tech LOC which refers to a contract between the coupon distributor and an advertiser, where the advertiser purchases, e.g., a print URL. It should be noted that in certain instances, a print URL may be considered to be an advertiser function, and hence the advertiser may be setup as a partner. Yet another LOC type includes an account-specific LOC used for coupon programs distributed at a limited number of retail network sites instead of on the coupon distributor network/network channels.

It should be further noted that a LOC may, in some embodiments, only be created by, e.g., an administrator of the coupon distributor, and once the requisite information is submitted regarding the LOC, the LOC can be generated in a PDF format or Word format. Thereafter, the LOC is sent to the advertiser and to a finance division of the coupon distributor for approval. Various change rules and fees can be applied to LOC creation as appropriate. Additionally, brand category exclusivity can be applied to LOCs and are valid for a specific time period.

The Batch Process module 346 is a part of the website application and handles offer/coupon publishing 348 and sending offer/coupon and consumer data to D2C partner 350, which occurs as background process(es) without any direct/human user interaction. For example, a plurality of offers/coupons may be collected into a set or “batch” and processed together for publication on, e.g., a partner site. Moreover, sending consumer data to the D2C partner functionality involves the previously described D2C partner integration, where the consumer data (e.g., retailer loyalty card number or any equivalent identified and any attached coupons) are written into a flat file and transmitted to the D2C partner via ftp, or some other appropriate file transfer method or protocol.

The Consumer Access module 352, like the Batch Process module 346, is part of the website application and contains features which are available to consumers through the coupon system website. Such features, which are available to the public, include, but are not limited to, offer/coupon display 354, offer/coupon print 356, user profile management 358, email subscription 360, and sweepstake/lead generation display 362.

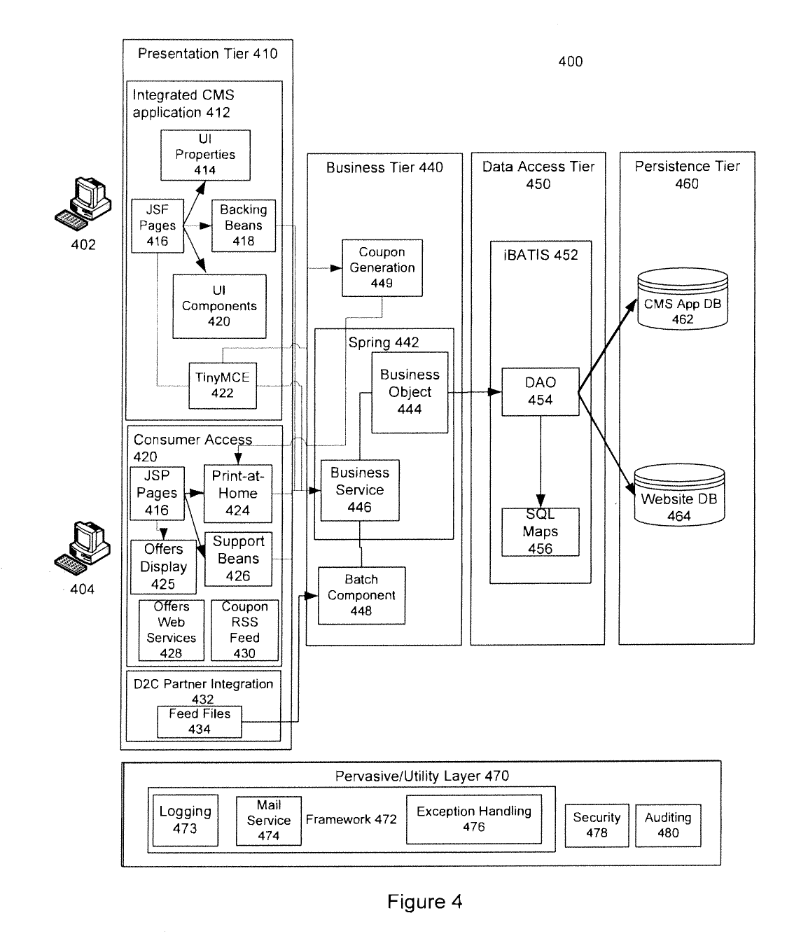

FIG. 4 is a diagram illustrating the application architecture of a coupon system 400. The application architecture is described in terms of “tiers” and the components within each tier. As shown in FIG. 4, the coupon system 400 includes a Presentation tier 410, a Business tier 440, a Data Access tier 450, a Persistence tier 460, and a Pervasive/Utility tier 470.

The Presentation tier 410 includes the integrated CMS application 412, a consumer access component 420, and a D2C partner integration component 432. The integrated CMS application 412 of the Presentation tier 410 utilizes JavaServer Faces (JSF) pages 416, a Java-based web application user interface (UI) development framework, to implement UI properties 414, backing beans 418 (for defining UI components/methods that perform UI component functions), and UI components 420. JSF differs from some other Model-View-Controller (MVC) frameworks in that JSF is a component-oriented and event-driven framework. JSF includes, among other features: a set of application programming interfaces (APIs) for displaying user GUI components and managing their state, handling events and input validation, page navigation using Extensible Markup Language (XML), etc.; tag libraries to access JSF components; predefined/default UI components; and server-side event handling. Additionally, the coupon system 400 utilizes MyFaces and RichFaces implementations of the JSF specifications. MyFaces is a particular JSF implementation promulgated by the Apache Software Foundation. RichFaces refers to a component library for JSF built on the Ajax framework, and includes Ajax components. Furthermore, the coupon system 400 utilizes various “custom” JSF components apart from the standard JSF components. It should be noted that other frameworks or development platforms may be utilized in accordance with various embodiments.

Moreover, the integrated CMS application 412 includes a “TinyMCE” tool 422 to create coupon templates. TinyMCE 422 is a JavaScript-based tool that provides rich text editing capabilities and allows saving a template in HTML format. This enables seamless integration of the coupon templates with the offer setup process. Custom visual as well as non-visual components may be created using the TinyMCE API to implement system-specific functionalities for the coupon template design process. For example, users such as advertisers may require the ability to add an image to a coupon template, resize it, and/or place the image in any position within the coupon template.

The Consumer Access component 420 of the Presentation tier 410 also utilizes JSF pages 416 to implement a print-at-home feature 424 and support beans 426. Additionally, the Consumer Access component 420 includes an offers web services feature 428, where the coupon system provides an integration option for partners through web services as described above. For example, the coupon system exposes a web service which provides coupon information for specific partners requesting it. The web service is hosted at the website application server and any end-point information may be given to those partners wishing to consume it. The partners use web services description language (WSDL) generated to consume the web service and provide their details in the request. Any coupons published for the partner are returned in a response to the partner request which is then rendered at the partner site using their own rendering logic.

A coupon RSS feed feature 430 is also provided in the Consumer Access component 420. Coupon data that will be available at the coupon system website may also be published as an RSS feed for consumers. Consumers may subscribe to this RSS feed and use a viewer tool to view coupon information at, e.g., their personal computer. This enables consumers to get updates regarding coupon information automatically at a computer without logging into the coupon system website.

The print-at-home component 424 that allows electronic coupons to be printed by a consumer may be embedded in the JSP and implemented using, e.g., an ActiveX and Java Applet client for MS Windows and Apple Mac-based clients, respectively. Such client components are preferably lightweight and can be used to get device IDs, e.g., the MAC address, of a client machine. Obtaining a device ID allows the coupon system to effectuate sending the coupon to a printer to be printed. Additionally, capturing the MAC address allows the coupon system, for example, to verify actual printing of a coupon. That is, the system can verify whether or not a print request/job is being sent to an actual printer/device rather than just some sort of data capture, such as a “print to file” request. Actual coupon generation will happen on the website server side using Hypertext Markup Language (HTML) to Portable Document Format (PDF) transformation. The generated PDF is sent to the client for printing using embedded JavaScript. Additionally, JSP pages 416 may also be utilized to implement the offer display component 425 for displaying offers/coupons on, e.g., the third-party coupon distributor website. In embodiments, the server may be configured to place a MAC address that has sent the coupon, not to a printer, but to a data capture such as a PDF file, on a blacklist, to prevent validation of more than one or any coupons containing this MAC address, thereby prevent fraudulent use of the coupon system. In embodiments, the server software may be configured to block printing from a data capture environment such as a PDF or other file. In embodiments, the server software may be configured to prevent data capture to data capture such as a PDF or other file.

Further still, the Presentation tier 410 includes a D2C partner integration component 432, which as described above, involves writing consumer data (e.g., retailer loyalty card number and any attached coupons) into a flat file and transmitting it to the D2C partner via ftp.

The Business tier 440 follows a Service Oriented Architecture (SOA) pattern. That is, all business logic is accessible through a set of services. These services are entry points to the business logic layer and to access any business components.

Spring 442 is a flexible framework for the Java platform with convenient features including at least the following: flexible bean management; aspect-oriented programming (AOP) support; web MVC framework; integration with other frameworks' scheduling support, email utility; Java EE Connector Architecture (JCA) support, Java Management Extensions (JMX) support; Java Message Service (JMS) support; web services; Object Relational (O/R) tool integration; and declarative transaction management. Spring 442 also provides a high-degree of abstraction and uses inversion of control resulting in increased decoupling, configurability, and management. Spring 442 is used for managing the backing bean, business service 446, business objects 444, EJBProxy (not shown) and data access objects (DAO) 454. Spring components such as the following are utilized: “Spring Core” for implementing Dependency Injection and managing bean life-cycle of business services and business objects; “Spring Object Relational Mapping (ORM)” for providing a template for the iBATIS persistence framework; “Spring AOP” for declarative transaction management; and “Spring AOP” for Message Driven Bean (MDB).

Business service component 446 follows an “Application Service” pattern and is an entry point for any business-related operation. Again, it follows the standard (SOA) pattern, and uses the required business objects 444 and if necessary, calls a transaction manager to mark a transaction boundary in order to provide a service to the Presentation tier 410. The business object component 444 holds the business logic. If the business logic involves, e.g., database access, the business logic invokes appropriate DAOs of the Integration Tier to perform various database operations involved in accomplishing the functionality.

The Business tier 440 further includes a batch component 448 which receives any feed files 434 from the D2C partner integration component 432 using ftp. That is, information, such as offer data, coupons selected by a consumer, etc. are sent to the batch component 448 for batch processing as described above, and redemption information from partners may be received from partners. Offer publishing (as also described above) is yet another function that can be implemented as a batch process which will be triggered using, e.g., a CRON job scheduler utility.

In terms of transaction management, Spring's declarative transaction will be utilized. That is, a business service component 446 may initiate some transaction and the transaction context will automatically propagate to the business objects 444 by the transaction manager component of Spring. The business services component 446 may also be responsible for the overall management of transactions by starting, committing and marking the boundary of the transactions based upon, e.g., client requests, and providing necessary transactional contexts to all business objects 444.

As described above, the TinyCME tool 422 is used to create coupon templates. An actual coupon may then be generated using a coupon generation component 449 from an existing coupon template. Any associated offer details are fed into a selected coupon template and a new HTML coupon file is generated, which may then be printed, via, e.g., the print-at-home function 424. The Coupon HTML file is converted to XML using an HTML Tidy tool, which in turn is converted to a Transform Formatting object (XMLFO) using, e.g., XML transformer, or some similar document/file transforming tool. From the Formatting object and standard Extensible Stylesheet Language (XSL), a PDF file is generated and saved in the website server. An Acrobat script embedded in the PDF using iText enables PDF document printing in silent mode.

The Data Access tier 450 is used as the integration junction of the integrated CMS application 412 and the coupon system website/website application with the data tier. DAOs 454 are deployed in this tier, where DAO classes generally relate to specific business functionality and integrate the business tier with data tier. The Data Access tier 450 also aids in connecting relational database management systems (RDBMS) using a standard Java Database Connectivity (JDBC) API or an ORM tool to keep the Business tier 440 isolated from any underlying persistence mechanism. iBATIS 452 refers to a Data Mapper Framework, that in contrast to the traditional JDBC approach that constitutes many operations other than writing Standard Query Language (SQL) queries, reduces the amount of requisite Java code. That is, the iBATIS SQLMap framework significantly reduces the amount of Java code normally needed to access a relational database. Moreover, iBATIS effectively eliminates the mixing of Java code with SQL Code. DAO classes may extend and use base custom DAO classes provided by the third-party coupon distributor.

A Persistence tier 460 represents one or more databases and their constituents. In the example application architecture illustrated in FIG. 4, two data stores are shown as being utilized. A first database 462 is utilized for maintaining any integrated CMS application data. A second database 464 is utilized to store data from the coupon system website. The integrated CMS application 412 may be responsible for pushing data from its own database 462 to the second database 464. For example, once an offer is verified, the offer is pushed to the coupon system website database 464. The Data Access tier 450 uses JDBC to connect to the database 464 and iBATIS 452 uses the JDBC connection to perform various SQL operations to achieve data persistence.

A Pervasive/Utility layer 470 is also part of the application architecture 400. A framework 472 includes a Logging component 473, a Mail Service component 474, and an Exception Handling component 476. The Logging component 472 internally uses log4j for tracking the exceptions/errors in the system. It should be noted that other logging utilities may be utilized other than the Java-based log4j. Logging is provided as a default for all critical errors, and logging levels may be made configurable as needed. With log4j, it is possible to enable logging at runtime without modifying the application binary, where statements can remain in shipped code without incurring a heavy performance cost. Further still, logging behavior can be controlled by editing a configuration file, without touching the application binary.

The Mail Service component 474 is a wrapper over the Java Mail API used to send/receive mail. The coupon system utilizes this API to send system-generated email notifications to, e.g., an administrator or consumer. Exception handling component 476 defines different types of exceptions relevant to each application tier. Various exceptions defined in the Framework 472 include, but are not limited to, DAO Exception, Business Exception, and Presentation Exception. Every layer/tier catches any potential run-time exceptions and converts them into layer-specific exceptions, where all exceptions may be logged with an easy to customize declarative mechanism. Meaningful error messages can be generated for display to a user such as an administrator or advertiser.

With regard to security, illustrated as a Security component 478, various embodiments utilize a “user to role” mapping mechanism. The role performs certain functionalities and users pertaining to the role will inherit all the behaviors of a particular role. Security with respect to the integrated CMS application involves a two-level authentication mechanism due to its use by internal and external users. That is, active directory authentication is provided for internal users, such as administrators of the coupon system, and database driven authentication is provided for external users, such as partners or advertisers. It should be noted that the active directory and/or the authentication database for external users may be configured as, e.g., one or more data repositories, that are separate from but accessible by or from the coupon system.

The Pervasive/Utility layer 470 may further include an Auditing component 480. Auditing can allow for maintaining an audit trail or a journaling function for, e.g., required database tables. Data administrators or database users can query a journal (history) table to measure changes, if any, that may have occurred over some particular period of time for a particular database table.

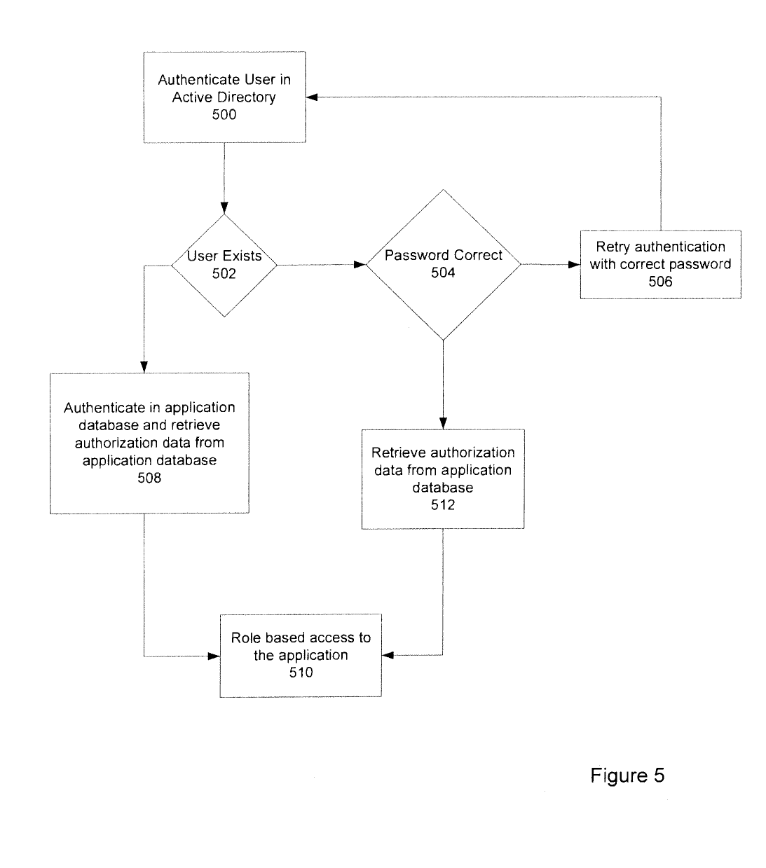

FIG. 5 illustrates the security authentication process, where a user (internal or external) is authenticated in the active directory at 500. At 502, it is determined whether the user exists. If the user does not exist in the active directly, the user is presumably an external user. Authentication is performed in the application database and authorization data is retrieved from the application database at 508. At 510, role-based access, as described above, is provided to the integrated CMS application for the external user. If it is determined at 502 that the user does exist in the active directory, the user is presumably an internal user. At 504, it is determined whether a password entered by the user is correct. If the password is not correct, authentication is retried at 506 with the correct password and returns to authentication of the user in the active directory at 500. If the password is deemed to be correct at 504, authorization data is retrieved from the application database at 512. Again, the appropriate role-based access is provided to the integrated CMS application at 510. It should be noted that active directory authentication may be implemented using, e.g., a Lightweight Directory Access Protocol (LDAP), authentication provider. Database driven authentication may be implemented using an appropriate user id/password authentication procedure.

Once a user's identity has been confirmed, the coupon system retrieves the accessible resources for the logged-in user based on Role Based Access Control (RBAC) from the database. Authorization is implemented using, e.g., URL-based web security and programmatic security. URL-based web security is performed by the website application server and is defined in web configuration files, where a virtual path is defined for each user group. Each virtual path is mapped to a security role, which is mapped to one or more groups. For example, a “/collections/” path is defined for the collection department of the third-party coupon generator/distributor, while a “/sales/” path is defined for sales users. Programmatic Security operates as follows. If a particular screen, such as a setup screen, is shared across multiple roles, e.g., one role is used to create an option and another role is used to approve it, the programmatic security framework will display an approve button only for its corresponding role. This is accomplished by associating the visibility and editability properties of the JSF components with the appropriate user privileges.

Security with regard to consumer access at the coupons system website will be made to be Secure Sockets Layer (SSL)-enabled by signing the coupon system website server with, e.g., an RSA-signed certificate from any trusted Certificate Authority (CA), e.g., VeriSign®, Thawte™, Comodo™, etc., although other security methods may be utilized. The coupons system website may also be configured not to accept any request on any non-secure ports to ensure that all communications to and from the website are secure. Enabling SSL ensures data security as it provides data encryption. Because the coupons system website is a publicly-accessible website available for consumers to access and print coupons pertaining to various offers, consumers need not necessarily register themselves to access/print coupons. Hence, no authentication is needed for consumers.

However, certain partners may require registration and for whom registration data is captured in coupon system. For such partners, a database authentication process is provided which will authenticate users (i.e., partners) using a user id and password captured during the registration process. Given that all users from a consumer access perspective are considered to be external users, there is no active directory authentication. Additionally, authorization is not needed for accessing the public-facing coupon system website.

Web services are secured using authentication, data-encryption and non-repudiation. With regard to authentication, web service clients will need to provide a user id and password for authentication in order to invoke a desired web service, such as provides coupon information for specific partners. A Servlet Filter is used to capture and intercept a request for the described web service, and initiate the authentication process. This filter may be configured with AxisServlet which handles all Simple Object Access Protocol (SOAP) requests. Additionally, the Servlet Filter will communicate with an authentication module to complete the authentication process. It should be noted that the authentication module implemented within the integrated CMS application can be reused for this purpose. User credentials will be sent from a client via an HTTP request. Data encryption and non-repudiation will be implemented using a Transport Layer Security mechanism configured by enabling SSL in the transport layer and installing an RSA signed certificate for the communication. There is no specific need for implementing authorization for accessing data via RSS feeds.

As indicated above, authorization is unnecessary for accessing data via RSS feeds. However, any coupon data published through RSS feeds will be secured by using SSL encryption. RSS Feeds are published via the coupon system website only, where the coupon system website will allow communication only through HTTPS. Thus, any RSS feeds will automatically be secured by the same secure channel. There is no specific need for implementing authentication or authorization for accessing coupon data via the RSS feeds.

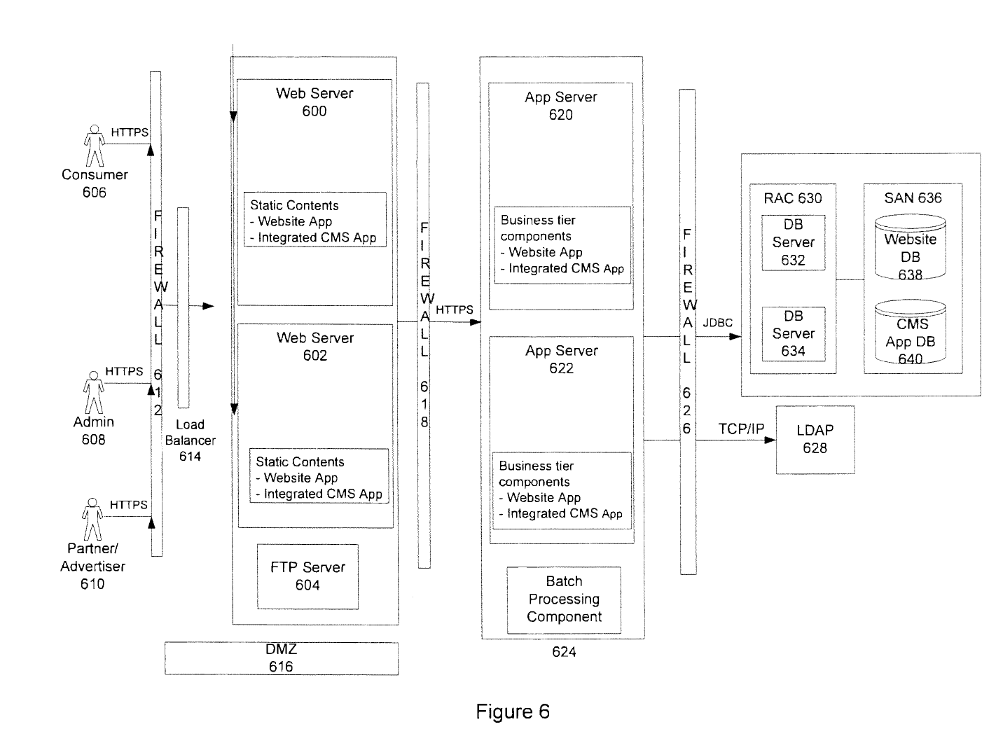

FIG. 6 illustrates the coupon system implementation in a distributed environment. Distribution of the coupon system components is relative to the aforementioned architectural tiers of the coupon system. Web servers 600 and 602 upon which the website application is implemented can be Apache HTTP Servers or some other server capable of accepting and service HTTP requests and responses, respectively. SSL is enabled in each of the web servers 600 and 602 to enforce all communication from users using HTTPS. It should be further noted that although two web servers are described herein, any number of web servers may be utilized in the coupon system. The web servers 600 and 602 also contain static files, such as HTML, JavaScript, CSS, images, and any other static content of a web page. Consumers 606 and partners/advertisers 610 communicate with the web servers 600 and 602 via the Internet. Administrator users 608 may communicate with the web servers 600 and 602 via the Internet as well, e.g., from within an intranet of the third-party coupon generator/distributor. All requests to the web servers 600 and 602 are routed via a firewall 612 for security. Partners 610 may also connect to one or more ftp servers 604 for downloading D2C integration data as described previously.

As further illustrated in FIG. 6, multiple application servers 620 and 622 are deployed in the application tier, and it should be noted that any number of application servers may be deployed in the coupon system in accordance with various embodiments. Such web servers may be implemented using, e.g., Oracle WebLogic Application Server 10.0 hosted in a Solaris environment. Clustering the application servers 620 and 622 provide a way to achieve load balancing and failover. However if server clustering, e.g., Oracle Weblogic Server clustering, is not feasible, a pseudo-clustered environment can be utilized by using a hardware-based load balancer 614. The load balancer 614 may be configured to be an entry point to the website application, where the load balancer 614 acts to balance the load across all web servers, e.g., web servers 600 and 602. Additionally, application servers 620 and 622 provide business tier components related to the integrated CMS application and the website application. Moreover, another firewall 618 may be implemented between the web servers 600 and 602 and the application servers 620 and 622. That is, all the requests from the web tier will be routed via the firewall 618, where the firewall 618 is configured to allow communication from the internal IP addresses of the web servers 600 and 602 and the ftp server 604 only. Application servers 620 and 622 can communicate with the database tier using JDBC connections which in turn will use an underlying Transmission Control Protocol/Internet Protocol (TCP/IP). Communications to an LDAP Server 628 are effectuated using an LDAP-specific custom protocol over TCP/IP protocol through a firewall 626.

It should be noted that the aforementioned web servers 600 and 602 and application servers 620 and 622 can refer to a physical hardware apparatus, such as a computer or processor upon which software for performing such processes is stored and executed. Alternatively, such servers may refer to the software itself, which by its nature requires some physical hardware apparatus for execution thereof. It should be further noted that the web servers 600 and 602 and the application servers 620 and 622 may be implemented in co-located servers or a single hardware apparatus/server.

Again, batch processing is performed via a batch processing component 624 implemented in the Solaris environment. Any job scheduling will be performed using the Solaris CRON utility discussed previously. Batch jobs will communicate with the database tier using JDBC over TCP/IP protocol.

The database tier, as illustrated in FIG. 6, shows two database servers 632 and 634, and the website database 638 and the integrated CMS application database 640. The databases servers 632 and 634 may be implemented using Oracle Database servers that are load balanced using an Oracle Real Application Clusters (RAC) environment 630. The application tier components communicate with the RAC 630 for connecting to one or more of the requisite databases instead of connecting to any specific server within the RAC 630. This substantially ensures failover management and proper load balancing by the RAC 630. Data is stored in an Oracle storage area network (SAN) 636. In accordance with one embodiment, only one copy of any data is maintained in the SAN 636, so that all of the database servers 632 and 634 within the RAC 630 share the same copy to the data. Alternatively, other data storage redundancy schemes may be used if desired. Again, more or less database servers and/or databases may be utilized to accommodate a desired amount of data to be stored.

As described above, the coupon system in accordance with various embodiments may provide for coupon distribution in the form of online printable coupons placed on a partner's microsite or dynamic coupon page, direct access, downloading, and printing via the coupon system website, or utilizing the D2C feature, where an offer can be linked to a loyalty card.

### Coupon Verification

As will be described below, the coupon system allows for a retailer to automatically verify the validity of a coupon when a customer attempts to redeem the coupon. Accordingly, a retailer can verify the save value and product purchase requirement of a coupon without having to save that information at the point of sale (POS) or retail site.

### QR Code Coupon

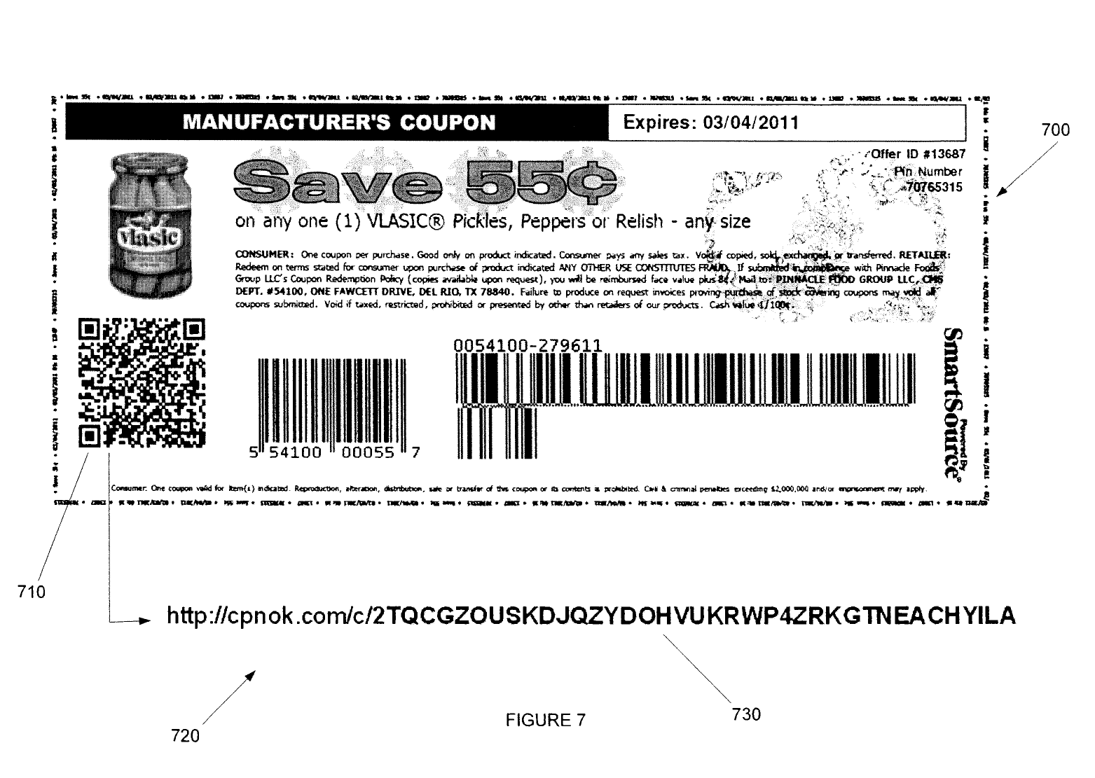

According to one embodiment and as shown in FIG. 7, the coupon system 200 may be configured to generate a coupon 700 that when printed has a coupon code 710. In some embodiments, the coupon code 710 is encoded with a URL 720 including an encrypted unique coupon identifier 730 for validating the coupon 700 at a retailer location when the coupon 700 is redeemed. In some embodiments, the URL is encoded with a 1D barcode, or a 2D barcode, or any other convenient code, and the encrypted unique coupon identifier 730 is encoded with the same or a different code. In some embodiments, the URL is not encoded, and the encrypted unique coupon identifier 730 is encoded with a 1D barcode, or a 2D barcode, or any other convenient code. In embodiments, the system dynamically obtains for each offer, information about an individual coupon requester's MAC address, to thereby track/identify the user device that causes generation of the coupon.

In embodiments, the coupon is printed or otherwise rendered on paper or another medium. In some embodiments, the coupon code 710 may be a quick response (QR) code, which is a type of 2D barcode. In some embodiments, the QR code may have dimensions of 1.25×1.25 inches. QR codes are intended to be decoded at high speed and may he read by dedicated readers and some camera/smart phones. As shown, the QR code comprises black modules arranged in a square pattern on a white background. The information encoded in the QR code can he text, URL or other data. Alternatively, the coupon can be presented electronically through a smartphone or other portable electronic device.

In order to generate the coupon 700, the coupon system 200 generates and associates with the coupon 700 a coupon code (e.g., QR code) 710 encoded with at least the unique coupon identifier 730, as well as a URL 720. That is, when a user requests the printing of coupon 700, the coupon system 200 generates the QR code 710 to be associated with the coupon 700, and adds the URL, and then facilitates their printing on the coupon 700 as shown in FIG. 7. In embodiments, the coupon identifier 730 is unique in order to prevent the coupon from being used more than one time, and to prevent fraud.

### Verification System

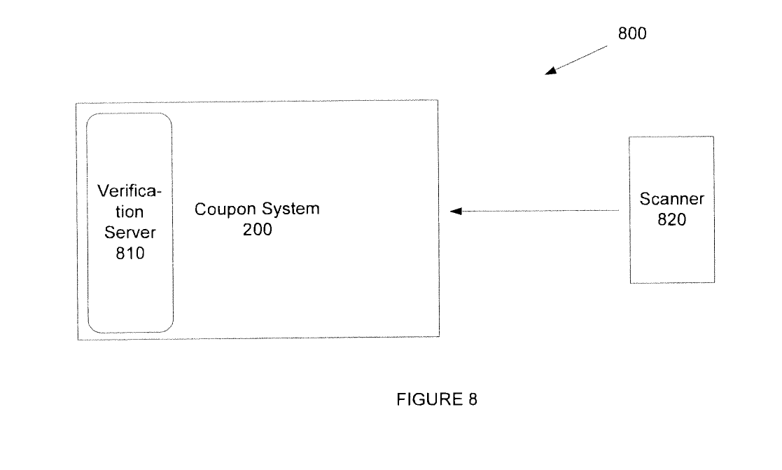

FIG. 8 shows a coupon verification system 800 for verifying the validity of a coupon 700 having a coupon code 710 to facilitate coupon redemption. The coupon verification system 800 includes the coupon system 200, having a verification server 810, and a scanner 820. The scanner 820 communicates with the coupon system 200 electronically and preferably via the Internet.

Generally, the scanner 820 may, in embodiments, be located at a POS where a user will seek to redeem the coupon 700. The scanner 820 can scan the URL 720 and the coupon code 710 on the coupon 700. The scanner may be any handheld or fixed device having suitable hardware and or software for scanning the coupon code 710, e.g., 2D QR codes, and the URL. Note that in embodiments, the coupon code 710 comprises both the URL 720 and the unique coupon identifier 730, encoded with the same code, e.g., 2D barcode, or another convenient code, and the scanner may be configured to decode at least the URL. In other embodiments, the URL 720 is encoded with a different code relative to the unique coupon identifier 730, and the scanner may be configured to at least decode or to only decode the coding for the URL 720. In other embodiments, the URL is not encoded, and the scanner may be configured to read the uncoded URL obtained from the scan and/or receive the uncoded URL via keying. In any event, the scanner obtains the URL from the coupon and accesses the URL 720 via a network connection to the Internet. Note that the ability to scan QR codes and other 2D codes can be integrated into the POS scanner used for scanning product and other one-dimensional barcodes. In embodiments, the scanner 820 may be a smart phone. In general, a commonly available device such as a smart phone may be used as the scanner 820 so that additional equipment is not needed at the POS.

Based on the URL 720 obtained, the scanner 820 accesses the URL 720 provided by the coupon system 200, which provides a link to the verification server 810. The scanner then provides the encrypted unique coupon identifier 730 for verification by the verification server 810. The verification server 810 decrypts the received unique coupon identifier 730 and determines whether the coupon 700 is valid based on the decrypted unique coupon identifier 730.

### Embodiment of Method of Verification

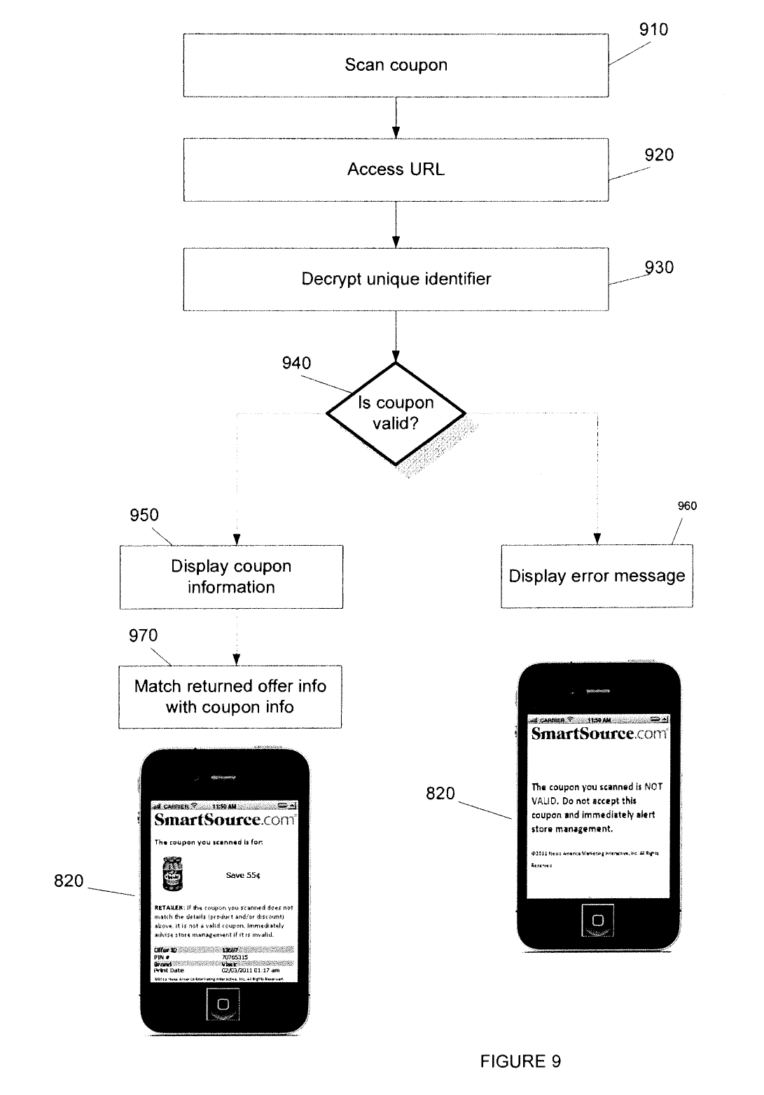

FIG. 9 is a flow chart illustrating a coupon verification process at a point-of-sale for verifying a coupon 700 generated by the coupon system 200. In one embodiment, the coupon is printed or otherwise rendered on paper or another media, and the coupon code 710 may be a quick response (QR) code comprising a type of 2D barcode, or a 3D bar code or other code. At step 910, a coupon code 710 on the coupon 700 is scanned or otherwise obtained in electronic form.

The coupon code 710 may comprise an encoded URL 720 and an encrypted unique coupon identifier 730. Alternatively, the URL may not be encoded. In embodiments the scanner is configured to decode the URL. In other embodiments, the scanner is configured to read an uncocled URL, and/or to receive a URL that is keyed into the scanner. In any event, the scanner obtains the URI. associated with the coupon.

In step 920, the scanner 820 uses its computer and a network connection to access URL 720 that was obtained to connect to a verification server 810 of the coupon system 200.

In step 930, the verification server 810 decrypts the unique coupon identifier 730. The decrypted unique coupon identifier 730 may include at least one selected from the group of information related to an offer, value, date, time of print, IP address, browser type or session information.

In step 940, the verification server 810 then determines whether the coupon 700 is valid based on the decrypted unique identifier 730. The uniqueness of the identifier may be used in embodiments to identify a specific desk top and/or to prevent fraudulent use of the coupon, as discussed previously.

FIG. 9 shows an embodiment where the verification determination is received by the scanner via the network connection and displayed on the screen display of the scanner 820. If the coupon is valid, in step 950, the coupon information is provided for display to a user, e.g., the POS retailer. In embodiments, the coupon information may comprise at least one selected from the group of brand, discount value, product purchase requirement or print date. Step 970 represents an operation of the retailer checking if the offer information (e.g., product identified, etc.) returned in step 950 for a valid offer matches the coupon scanned at the POS. If the coupon is not valid, in step 960 an error message is displayed to the user.

As noted, in embodiments, a user customer's media access control (MAC) address may be captured during the process of printing the coupon at home or at another location. In some embodiments, the MAC address capture may occur during a session where a user navigates to a website for a coupon server, and clicks buttons or other indicators on a web page at the coupon server web site to cause the printing of a coupon. Computer code triggered from the web page may capture the MAC address of the user appliance and/or a printer designated by the user, and encode the MAC address in the coupon code on the coupon, e.g., the 2D or 3D barcode or another code. In embodiments, the MAC address may also be recorded in a database.

When a coupon is presented at check-out, and if the coupon is determined to be fraudulent (e.g., an offer that doesn't exist, like $50 off a carton of Marlboros), the MAC address determined from the coupon code may be blacklisted on the coupon server. In embodiments, this blacklisting may comprise recording or transmitting for recordal the MAC address in a database listing for MAC addresses that use fraudulent coupons. This blacklisting on the coupon server prevents future printing of coupons with that MAC address or requested from that MAC address, Fraud may also be detected at a coupon clearinghouse. Accordingly, an aspect of embodiments of the invention is that the system and method allows a match up of a fraudulent coupon presented and a MAC address, thereby allowing fraudulent coupons to be caught before they are redeemed,

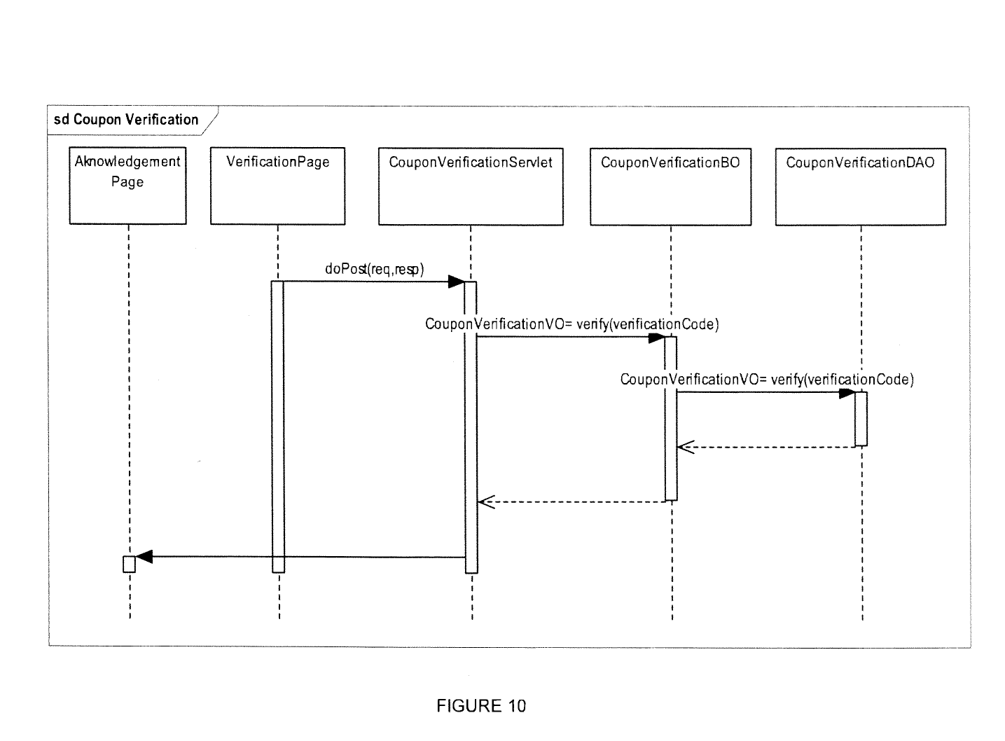

FIG. 10 is a sequence diagram illustrating various processes that may be performed to verify a coupon. Note that this is a non-limiting example of a method for verification. A doPost( )method in a CouponVerificationServlet class is called, and the encrypted 2D or 3D bar code or another code is decrypted in the CouponVerificationServlet into an Offer ID and Pin Number. The Offer ID is unique to each offer. The PIN is unique to each respective print copy. Thus, there is a different PIN for each respective print copy.

If decryption happens successfully, then the CouponVerificationServlet calls a verify( ) method in a CouponVerificationBO (business object) class with the decrypted values (Offer ID and Pin Number) as parameters. The business object (BO) class will further call a verify( ) method in CouponVerificationDAO (database access object) class which fetches details from a coupon database and stores the values in a CouponVerificationVO object. The CouponVerificationVO object will be returned to the BO class and then to the Servlet class and the object will be stored at a location HttpServletRequest attributes. The request will then be redirected to CouponVerification.jsp which will acknowledge all the details of the Coupon that is printed which are fetched from the Database. If the verification fails, redirection to CouponVerification.jsp occurs, which will cause display of an ‘Invalid Coupon’ message.

Various embodiments are described herein with reference to drawings. These drawings illustrate certain details of specific embodiments that implement the systems and methods and programs of the present invention. However, describing the invention with drawings should not be construed as imposing on the invention any limitations that may be present in the drawings. Various embodiments contemplate methods, systems and program products on any machine-readable media for accomplishing its operations. The embodiments of the present invention may be implemented using an existing computer processor, or by a special purpose computer processor incorporated for this or another purpose or by a hardwired system.

As noted above, various embodiments include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to store desired program code in the form of machine-executable instructions or data structures and which can be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Various embodiments are also described in the general context of method processes which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing processes of the methods disclosed herein. The particular sequence of such executable instructions or associated data structures represent examples of corresponding acts for implementing the functions described in such processes and it is understood that the order of these processes may differ from what is depicted. Also two or more processes may be performed concurrently or with partial concurrence. Such variation will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching processes, correlation processes, comparison processes and decision processes. It should also be noted that the words “component” and “module” as used herein and/or in the claims is intended to encompass implementations using one or more lines of software code, and/or hardware implementations, and/or equipment for receiving manual inputs.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD-ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed. The embodiments were chosen and described in order to explain the principals of the invention and its practical application to enable one skilled in the art to utilize the invention in various embodiments and with various modifications as are suited to the particular use contemplated. Other substitutions, modifications, changes and omissions may be made in the design, operating conditions and arrangements of the preferred and other exemplary embodiments without departing from the spirit of the present invention.

1. A system, comprising:
one or more computers comprising one or more non-transitory storage media wherein the one or more non-transitory storage media store computer-executable instructions that, when executed, cause the one or more computers to perform the steps:
receiving, using the one or more computer, access on a webpage from a customer with a request to print a coupon;
receiving, using the one or more computer, MAC data of the customer client and of a device designated by the customer to print the coupon;
accessing, using the one or more computer, one or more electronic databases, stored on one or more computer-readable media, comprising coupon information and unique coupon identifiers for valid coupons including information on the coupon;
determining, using the one or more computers, whether the device designated by the customer is a printer;
determining whether the customer is listed in a blacklist database;
providing, using the one or more computers, when the coupon is invalid or when it is determined that the device designated by the customer is not a printer, the MAC data of the customer to the blacklist database to prevent authorizing printing of other coupons in response to a subsequent request received for a coupon printing authorization having the MAC data of the customer;
transmitting, using the one or more computers and network connection, when the coupon is valid and the device designated by the customer is a printer and the customer is not on the blacklist database, the coupon to be printed; and
validating the coupon when presented at a retailer location, using the one or more computers, based at least in part on the unique coupon identifier on the coupon.

2. The system as defined in claim 1, wherein the unique identifier is encrypted; and further comprising computer-executable instructions that, when executed, cause the one or more computers to perform the steps:
decrypting, using the one or more computers, the encrypted unique identifier; and
generating data for display or posting of an error message if the decrypted unique identifier is not a valid coupon identifier.

3. The system as defined in claim 1, wherein the coupon information comprises at least one selected from the group of brand, discount value, product purchase requirement, and print data, and wherein the unique identifier is a 2D barcode.

4. The system as defined in claim 1, wherein the coupon information comprises at least one selected from the group of brand, discount value, product purchase requirement, and print data, and where the unique identifier is a quick response code.

5. A method, comprising:
receiving, using one or more computer, access on a webpage from a customer with a request to print a coupon;
receiving using the one or more computer, MAC data of the customer client and of a device designated by the customer to print the coupon;
accessing, using the one or more computer, one or more electronic databases, stored on one or more computer-readable media, comprising coupon information and unique coupon identifiers for valid coupons including information on the coupon;
determining, using the one or more computers, whether the device designated by the customer is a printer;
determining whether the customer is listed in a blacklist database;
providing, using the one or more computers, when the coupon is invalid or when is determined that the device designated by the customer is not a printer, the MAC data of the customer to the blacklist database to prevent authorizing printing of other coupons in response to a subsequent request received for a coupon printing authorization having the MAC data of the customer; and
transmitting, using the one or more computers and network connection, when the coupon is valid and the-device designated by the customer is a printer and the customer is not on the blacklist database, the coupon to be printed; and
validating the coupon when presented at a retailer location, using the one or more computers, based at least in part on the unique coupon identifier on the coupon.

6. The method as defined in claim 5, wherein the unique identifier is encrypted; and further comprising:
decrypting, using the one or more computers, the encrypted unique identifier; and
generating data for display or posting of an error message if the decrypted unique identifier is not a valid coupon identifier.

7. The method as defined in claim 5, wherein the coupon information comprises at least one selected from the group of brand, discount value, product purchase requirement, and print data, and wherein the unique identifier is a 2D barcode.

8. The method as defined in claim 5, wherein the coupon information comprises at least one selected from the group of brand, discount value, product purchase requirement, and print data, and where the unique identifier is a quick response code.
